(19) United States
(12) Patent Application Publication
(10) Pub. No.: US 2008/0018281 A1
(43) Pub. Date: Jan. 24, 2008

(54) CONTROL APPARATUS OF BRUSHLESS DC MOTOR AND CONTROL METHOD THEREOF

(75) Inventors: Chang Hyun Kim, Suwon-si (KR); Dae Won Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/752,998

(22) Filed: May 24, 2007

(30) Foreign Application Priority Data
Jul. 10, 2006 (KR) 2006-64545

(51) Int. Cl. H02P 21/14; H02P 7/00

(52) U.S. Cl. 318/445; 318/268

(57) ABSTRACT

A controlling apparatus of a BLDC motor and a controlling method thereof. A replacement of a motor with another motor having the different number of poles is automatically detected due to a variation of a load current of the BLDC motor, and rotation speed estimation information of the motor is automatically modified according to the number of poles of the replaced motor to accurately estimate an actual rotation speed of the motor.

### CROSS-REFERENCE TO RELATED APPLICATIONS

This application claims priority under 35 U.S.C. § 119(a) from Korean Patent Application No. 2006-64545, filed on Jul. 10, 2006, in the Korean Intellectual Property Office, the disclosure of which is incorporated herein by reference in its entirety.

### BACKGROUND OF THE INVENTION

1. Field of the Invention

The present general inventive concept relates to a controlling apparatus of a BLDC motor and a controlling method thereof.

2. Description of the Related Art

Generally, a brushless DC motor is a DC motor designed to eliminate a brush functioning as a commutator and to exhibit a property of a conventional DC motor, and the brushless DC motor is classified into a sensor type BLDC motor and a sensorless type BLDC motor according to whether there is a sensor to detect a position and a rotation speed of a rotor or not.

The sensor type BLDC motor, as illustrated in FIG. 1, includes a cylindrical casing 100, a stator 101 fitted into the casing 100 and having three-phase coils (a U-phase coil, a V-phase coil, and a W-phase coil) winding around a plurality of slots, and a rotor 102 rotatably inserted into the stator 101 and having permanent magnets with different poles (an N-pole and an S-pole) alternately disposed around a rotation shaft.

Moreover, the sensor type BLDC motor further includes three hall sensors 103 continuously arranged between the stator 101 and the rotor 102, i.e., between respective teeth of serial slots of the stator 101, to detect positional information of the rotor 102 in order to obtain rotation speed information of the rotor 102.

As illustrated in FIG. 2, when the rotor 102 rotates and power is supplied to the respective hall sensors 103, the respective hall sensors 103 output signals Hu, Hv, and Hw corresponding to the number of poles of the permanent magnet. The determines the position of the rotor using the hall sensors and outputs a gate signal corresponding to the position of the rotor 102 to an inverter circuit to control the rotor 102, recognizes a frequency generator (FG) pulse indicating that the rotor is rotating, and detects one revolution of the rotor due to the FG pulse to estimate the rotation speed of the motor, to control a rotation speed of the motor.

The controller estimates the rotation speed of the motor based on information about the number of poles of the motor inputted by a user. In other words, the controller estimates the rotation speed of the motor by counting the FG pulses generated by the respective hall sensors 103 and determining that the rotor 103 rotates by one revolution when the counted number per each revolution is a predetermined number corresponding to the number of the poles of the motor.

Generally, a four-pole motor has six FG pulses per revolution, a six-pole motor has twelve FG pulses per revolution, and sixteen-pole motor has twenty four FG pulses per revolution.

For example, when an 8-pole motor is replaced with the 16-pole motor, a user switches the number of poles to 16 poles using a pole number changing switch. By doing so, the controller recognizes the number of poles of the motor is 16-poles and estimates the rotation speed of the motor by applying the number of the FG pulses corresponding to the 16-poles.

However, when the 8-pole motor is replaced with the 16-pole motor, and the user mistakenly or incorrectly switches the 8-pole motor to the 4-pole motor or does not switch the number of the poles, the controller recognizes the replaced motor as the 4-pole motor or the 8-pole motor to estimate the rotation speed of the motor. As a result, the motor operates incorrectly such that it rotates excessively or insufficiently.

### SUMMARY OF THE INVENTION

The present general inventive concept provides a BLDC motor controlling apparatus to automatically detect a replacement of a motor with another motor having a different number of poles to control a rotation speed of the replaced motor and a controlling method thereof.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a controlling apparatus of a BLDC motor to estimate a rotation speed of the BLDC motor, the controlling apparatus including a current detector to detect a load current of the BLDC motor, and a controller to detect a replacement of the BLDC motor with another BLDC motor having a different number of poles based on a variation of the detected load current from a reference load current, to determine the number of poles of the replaced motor, to modify reference rotation speed estimation information to new rotation speed estimation information corresponding to the number of poles of the replaced BLDC motor, and to control a rotation speed of the replaced BLDC motor according to the new rotation speed estimation information.

The rotation speed estimation information may be the number of frequency generator pulses per revolution of a rotor of the BLDC motor.

The number of frequency generator pulses per revolution of the rotor of the BLDC motor may be six when the BLDC motor is a 4-pole BLDC motor, twelve when the BLDC motor is an 8-pole BLDC motor, and twenty four when the BLDC motor is a 16-pole BLDC motor.

The controller may detect that the BLDC motor is replaced with the another BLDC motor having the number of poles greater than a reference number of poles when the detected load current is less than a reference load current, and that the BLDC motor is replaced with the another BLDC motor having the number of poles less than the reference number of poles when the detected load current is greater than the reference load current.

The controller may determine the number of poles of the replaced BLDC motor using a current difference between the detected load current and the reference load current.

The foregoing and/or other aspects of the general inventive concept may also be achieved by providing a controlling method of a BLDC motor of estimating a rotation speed of the BLDC motor using rotation speed estimating information for estimation of a rotation speed differently set according to the number of poles of the BLDC motor, the controlling method including estimating the rotation speed of the BLDC motor using reference rotation speed estimation information, compensating the rotation speed such that the estimated rotation speed reaches a target rotation speed, detecting a load current of the BLDC motor after the compensating, detecting replacement of the BLDC motor with another BLDC motor having a different number of poles based on a variation of the detected load current in comparison to a reference load current and determining the number of poles of the replaced BLDC motor, and modifying the reference rotation speed estimation information to new rotation speed estimation information corresponding to the determined number of poles of the BLDC motor.

The detecting of the replacement of the BLDC motor may include determining that the BLDC motor is replaced with the another BLDC motor having the number of poles greater than a reference number of poles when the detected load current is less than the reference load current, and determining that the BLDC motor is replaced with the another BLDC motor having the number of poles less than a reference number of poles when the detected load current is greater than the reference load current.

The number of poles of the BLDC motor may be determined by a difference between the detected load current and the reference load current.

The rotation speed estimation information may be the number of frequency generator pulses per revolution of a rotor of the BLDC motor.

The foregoing and/or other aspects of the general inventive concept may also be achieved by providing a controlling apparatus to control a BLDC motor, the controlling apparatus including a BLDC motor, an inverter to drive the BLDC motor, an inverter driver to control the inverter, a detector connected between the inverter and a potential to detect a current of the inverter, and a controller to determine the number of poles of the BLDC motor according to the detected current and a reference.

The foregoing and/or other aspects of the general inventive concept may also be achieved by providing a control method of a controlling apparatus to control a BLDC motor, the control method including comprising: driving a BLDC motor using an inverter, controlling the inverter, detecting a current of the inverter, and determining the number of poles of the BLDC motor according to the detected current and a reference.

The foregoing and/or other aspects of the general inventive concept may also be achieved by providing a computer readable recording medium containing computer readable codes as a program to perform a control method of a controlling apparatus to control a BLDC motor, the control method including driving a BLDC motor using an inverter, controlling the inverter, detecting a current of the inverter, and determining the number of poles of the BLDC motor according to the detected current and a reference.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a front sectional view illustrating a conventional brushless DC motor;

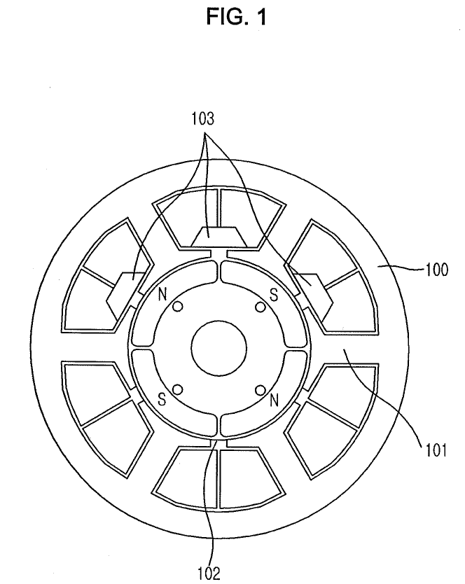

FIG. 2 is a timing graph illustrating an FGL pulse signal and a conventional BLDC hall sensor signal of the conventional brushless DC motor of FIG. 1;

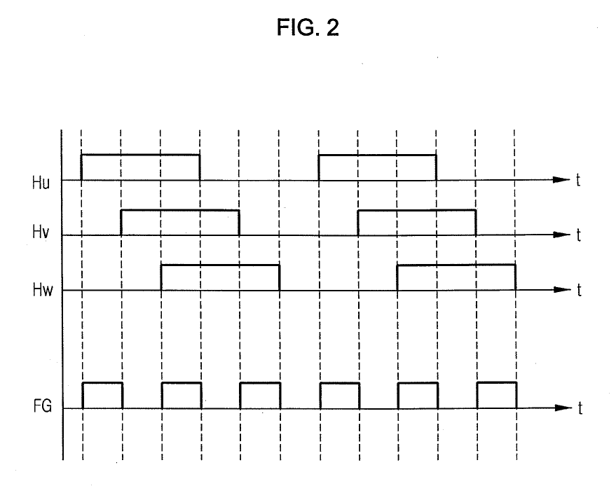

FIG. 3 is a block diagram illustrating a controlling apparatus of a BLDC motor according to an embodiment of the present general inventive concept;

FIG. 4 is a flowchart illustrating a control method of a controlling apparatus of a BLDC motor according to an embodiment of the present general inventive concept; and

FIG. 5 is a flowchart illustrating a control method of a controlling apparatus of a BLDC motor according to another embodiment of the present invention.

### DETAILED DESCRIPTION OF THE PREFERRED EMBODIMENTS

Reference will now be made in detail to the embodiments of the present general inventive concept, examples of which are illustrated in the accompanying drawings. The embodiments are described below to explain the present general inventive concept by referring to accompanying drawings.

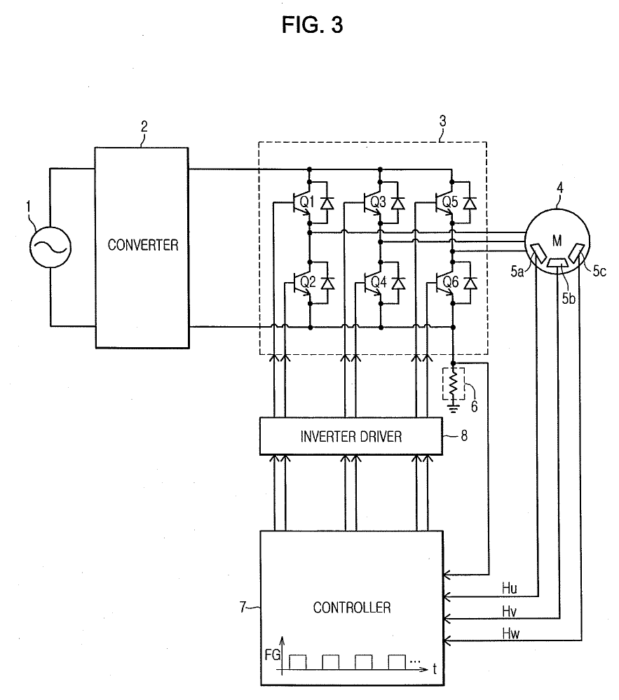

FIG. 3 is a view illustrating a controlling apparatus of a BLDC motor according to an embodiment of the present general inventive concept. The controlling apparatus includes an AC power source 1, a converter 2 to convert a AC power of the AC power source 1 into a DC power, an inverter 3 to invert the DC power of the converter 2 into an AC power, rotor position detectors 5a, 5b, and 5c including hall sensors to detect a position of a rotor of the BLDC motor, an inverter driving unit 8 to drive the inverter 3, and a controller 7 to control the inverter 3 by outputting a control signal to the inverter driving unit 8 to control a rotation speed of the BLDC motor 4 using information on the rotor position detected by the rotor position detector 5a, 5b, and 5c.

The inverter 3 includes a plurality of transistors Q1 to Q6 switched on/off according to a driving signal from the inverter driving unit 8 to supply the DC power converted by the converter 2 to the respective phases of the rotor of the BLDC motor 4.

The BLDC motor 4 is employed in a blower of an air conditioner, an air purifier, and so on, and includes a stator to generate a uniform rotational magnetic field according to an electric power supplied from the inverter 3 and the rotor rotated by the rotational magnetic field of the stator.

The rotor position detectors 5a, 5b, and 5c include three hall sensors disposed between the stator and the rotor of the BLDC motor 4 to detect the position information of the rotor in order to obtain information about the rotation speed of the BLDC motor 4.

The controller 7 estimates the rotation speed of the BLDC motor 4 based on the position information of the BLDC motor 4 detected by the rotor position detectors 5a, 5b, and 5c during the rotation of the BLDC motor 4, and compares the estimated rotation speed of the BLDC motor with a predetermined rotation speed. According to the comparison, the controller 7 outputs a speed control command to compensate a speed error in the form of a pulse width modulated control signal such that an actual rotation speed of the BLDC motor 4 reaches a target rotation speed thereof.

The inverter driving unit 8 generates a driving signal to turn on/off the respective transistors Q1 to Q6 of the inverter 3 according to the pulse width modulated control signal from the controller and outputs the same to the respective transistors Q1 to Q6 of the inverter 3.

As described above, when an 8-pole motor is replaced with another motor, such as a 16-pole motor, and a pole-number switch is switched in error or is never switched due to a user's mistake, malfunction occurs since the controller incorrectly recognizes the replaced motor as a 4-pole motor or the 8-pole motor and estimates the rotation speed of the motor by applying an FG pulse number per revolution corresponding to the 4-pole motor or the 8-pole motor.

Thus, in the present embodiment, in order to automatically detect the replacement of a motor with another motor having a different number of poles and to perform the rotation speed control according to a changed number of poles, the rotation speed control is performed by detecting the replacement of the motor with another motor having the different number of poles using variation of a load current of the motor in association with the number of poles of the motor, by automatically determining the number of poles of the replaced motor, and by changing rotation speed estimation information according to the number of poles. For example, in a case that a rotation speed of a motor having 8-poles is set to 800 rpm as a reference, if the 8-pole motor is replaced with the 16-pole motor, a double FG pulse signal is outputted, and a conventional BLDC motor seems to be controlled at 800 rpm in a conventional method of controlling a conventional BLDC motor. However, actually, the conventional BLDC motor rotates at 400 rpm. In this case, since a load at 400 rpm is significantly less than a load at 800 rpm, a load current is also measured to be low.

Thus, based on a variation of the load current in comparison to a reference load current, the number of poles of the motor must be automatically determined to be 16-poles, and the rotation speed of the motor must be correctly estimated by applying new rotation speed estimation information corresponding to the 16-poles, i.e., 24 FG pulses per revolution instead of rotation speed estimation information corresponding to the 8-poles, i.e., 12 FG pulses per revolution.

On the other hand, in a case that a rotation speed of a motor having 8-poles is set to 800 rpm as a reference, if the 8-pole motor is replaced with the 4-pole motor, a ½ time FG pulse signal is outputted, and a conventional BLDC motor seems to be controlled at 800 rpm. However, actually, the BLDC motor rotates at 1600 rpm. In this case, since a load at 1600 rpm is prominently greater than a load at 800 rpm, a load current is also measured high.

Thus, based on the variation of the load current, the number of poles of the motor must be automatically determined as 4-poles, and the rotation speed of the motor must be correctly estimated by applying rotation speed estimation information corresponding to the 4-poles, i.e., six (6) FG pulses per revolution, instead of rotation speed estimation information corresponding to the 8-poles, i.e., 12 FG pulses per revolution.

To this end, the controlling apparatus of the BLDC motor 4 according to the present general inventive concept includes a current detector 6 to detect a load current of the BLDC motor 4. The current detector 6 is implemented by a shunt resistor and is connected to the inverter 3 to detect a current flowing through the BLDC motor 4, i.e., the load current of the BLDC motor 4.

Thus, the controller 7 detects the load current of the BLDC motor 4 using the current detector 6, automatically detects the replacement of the BLDC motor 4 with another motor having a different number of poles based on the variation of the current between the detected load current and a reference load current, automatically determines the number of poles of the replaced motor, and accurately estimates the rotation speed of the motor by applying the number of FG pulses per revolution corresponding to the automatically determined number of poles of the motor.

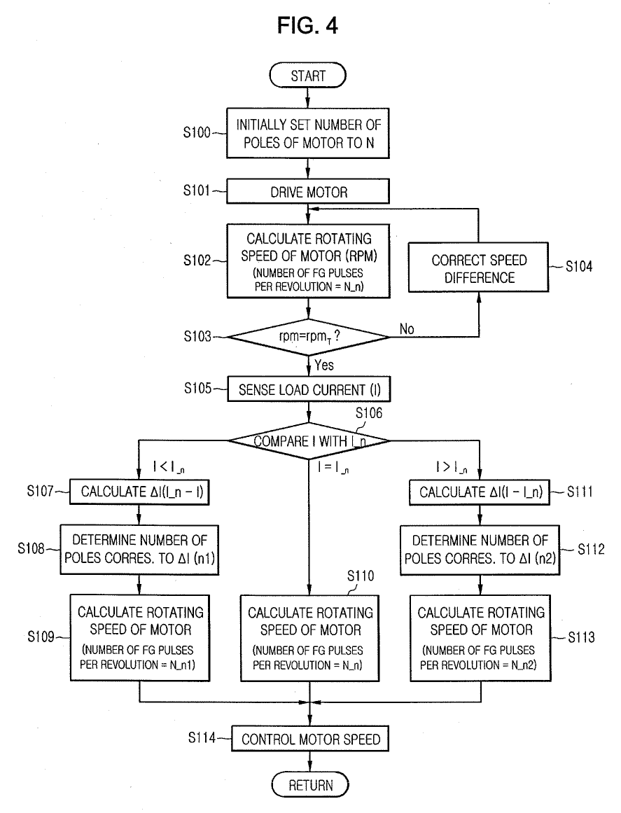

FIG. 4 is a flowchart illustrating a control method of controlling a controlling apparatus of a BLDC motor according to an embodiment of the present general inventive concept. Referring to FIGS. 3 and 4, the controller 7 initially sets the number of poles of the motor to n at operations S100 and S101 and drives the motor.

The controller 7 applies the rotation speed estimation information (reference rotation speed estimation information) corresponding to the pole number n, i.e., the number of FG pulses N_n, to estimate the rotation speed of the motor at operation S102. At operation S103, whether the estimated rotation speed rpm of the motor reaches a target rotation speed rpmT is determined. As a result of the determination of operation S103, when the estimated rotation speed rpm of the motor does not reach the target rotation speed rpmT, a rotation speed error is corrected at operation S104 and the operation S102 is performed again.

Meanwhile, when the estimated rotation speed rpm of the motor reaches the target rotation speed rpmT, the load current of the BLDC motor 4 is detected through the current detector 6 at operation S105. At operation S106, the detected load current I is compared with a current value of a reference load current I_n at the number of poles of the motor n.

If, as a result of the determination of operation S106, the detected load current I is less than the reference load current I_n at the number of poles n, it is determined that the motor has been replaced with another motor having the number of poles greater than the initially set number of poles of the motor, i.e., the reference number of poles, is detected. In this case, in order to determine a great number which the number of poles is changed to, a current difference ΔI=I_n−1 between the reference load current I_n at the number of poles n and the detected load current I is estimated at operation S107. At operation S108, the number of poles is determined, using the estimated current difference, from the numbers of poles greater than the number of poles n. In this case, the number of poles is changed to correspond to predetermined ranges of the estimated current difference, and is set to a great number of poles when the current difference is high, when the detected load current I is lower than the reference load current I_n at the number of poles n of the motor. At operation S109, the number of FG pulses N_n1 per revolution corresponding to the determined number of poles n1 of the motor is applied to estimate the rotation speed of the motor.

When the detected load current I is identical to the reference load current I_n at the number of poles n as a result of the determination in operation S106, since the initially predetermined number of poles, i.e. the reference number of poles is identical to the present number of poles, and no replacement of the motor is detected, the rotation speed of the motor is estimated by applying the number of FG pulses N_n corresponding to the initially predetermined number of poles n at operation S110 in a same way as at the operation S102.

As a result of the determination in the operation S106, if the detected load current I exceeds the reference load current I_n at the number of poles n, it is determined that the motor has been replaced with another motor having the number of poles smaller than the initially set number of poles of the motor, i.e., the reference number of poles, is detected. In this case, in order to determine a small number which the number of poles is changed to, a current difference ΔI=I_n−1 between the reference load current I_n at the number of poles n and the detected load current I is estimated at operation S111. At operation S112, the number of poles is determined, using the estimated current difference, from the numbers of poles smaller than the number of poles n. In this case, the number of poles is set to correspond to predetermined ranges of the estimated current difference, and is set to the small number of poles when the current difference is high, i.e., as the detected load current I is higher than the reference load current I_n at the number of poles n of the motor. After that, at operation S113, the number of FG pulses N_n2 per revolution corresponding to the determined number of poles n2 of the motor is applied to estimate the rotation speed of the motor.

At operation S114, the speed control of the BLDC motor 4 to correct the speed difference between the rotation speed of the motor estimated at operations S109, S110, and S113 and the target rotation speed is performed.

In the above-described embodiment, for example, at any case such as the replacements of the 4-pole motor with the 8-pole motor, the 16-pole motor, or a 32-pole motor, or of the 16-pole motor with the 8-pole motor or the 4-pole motor, the change of the number of poles of the motor can be automatically determined. However, the present embodiment illustrates replacement of the motor from the 8-pole motor to the 4-pole motor or to the 16-pole motor as an example, and a controlling logic is more simplified. By doing so, when the detected load current I exceeds the reference load current I_n at the number of poles of the motor, it is determined that the motor is replaced with another motor having the number of poles smaller than the initially predetermined number of poles by one level. When the detected load current I is less than the reference load current I_n at the number of poles of the motor, it is determined that the motor is replaced with another motor having the number of poles greater than the initially predetermined number of poles by a one level. It is possible that the controller generates a signal indicating that the BLDC motor is not a reference BLDC motor according to the determined number of poles

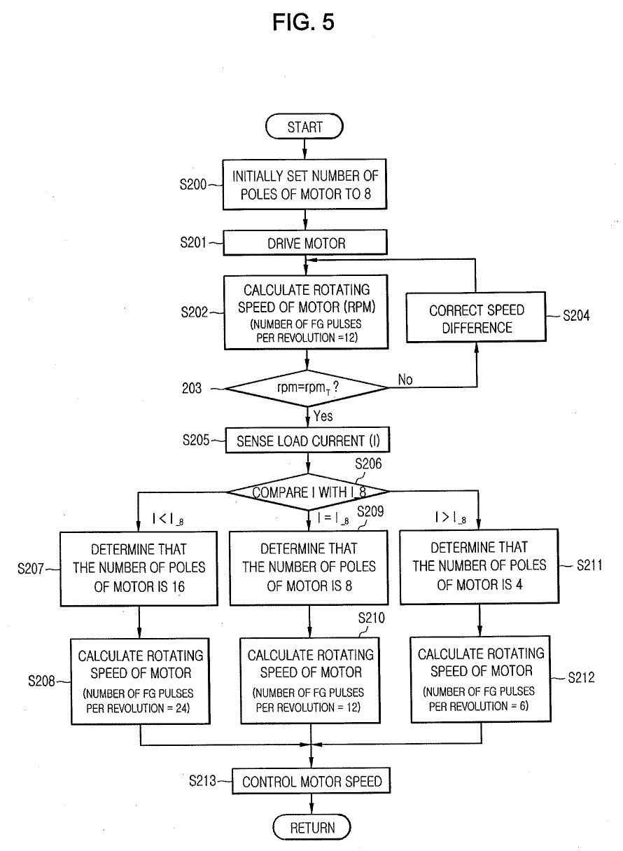

FIG. 5 is a flowchart illustrating a control method of a controlling apparatus to control a BLDC according to an embodiment of the present general inventive concept when the 8-pole motor is replaced with the 4-pole motor or the 16-pole motor. Referring to FIGS. 3 and 5, the controller 7 initially sets the number of poles of the motor to 8 and drives the motor at operations S200 and S201.

The controller 7 estimates the rotation speed of the motor by applying 12 FG pulses, corresponding to 8 poles at operation S202. At operation S203, the controller 7 determines whether the estimated rotation speed rpm of the motor reaches the target rotation speed rpmT. As a result of the determination in the operation S203, when the estimated rotation speed rpm of the motor does not reach the target rotation speed rpmT, the speed error is corrected at operation S204 and the operation S202 is performed again.

Meanwhile, when the estimated rotation speed rpm of the motor reaches the target rotation speed rpmT, the load current of the motor 4 is detected by the current detector 6 at operation S205. At operation S206, the detected load current I is compared with the reference load current I_{—8 for} 8 poles.

If, as a result of the determination in the operation S206, since the motor is replaced with a motor having the number of poles greater than 8, the initially predetermined number of poles when the detected load current I is lower than the reference load current I_{—8 for} 8 poles, it is determined that the number of poles is 16 at operation S207.

At operation S208, the rotation speed of the motor is estimated by applying 24 FG pulses per revolution, corresponding to 16 poles.

As a result of the determination in the operation S206, if the present number of poles is identical to 8, the initially predetermined number of poles, the detected load current I is identical to or substantially same as the reference load current I_{—8 for} 8 poles, such that at operation S210, the rotation speed of the motor is estimated by applying 12 FG pulses, corresponding to 8 poles, in the same way as the operation S202.

As a result of the determination in the operation S206, if the motor is replaced with a motor having the number of poles smaller than 8, the initially predetermined number of poles, the detected load current I exceeds the reference load current I_{—8 for} 8 poles, such that at operation S211, the number of poles is determined to be 4. During the operation S212, the rotation speed of the motor is estimated by applying 6 FG pulses per revolution, corresponding to 4 poles.

At operation S213, the speed control of the motor to correct the speed difference between the rotation speeds of the motor estimated during the operations S208, S210, or S212 is performed.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains. That is, the method of FIGS. 4 and 5 may be performed using the computer-readable codes on a computer-readable recording medium.

As described above, according to the present general inventive concept, the replacement of a motor with another motor having the different number of poles is automatically detected due to the variation of the load current of the BLDC motor, and the rotation speed estimation information of the motor is automatically modified according to the number of poles of the replaced motor to accurately estimate the actual rotation speed of the motor. Thus, the complexity of worker manually inputting information about the number of poles of the replaced motor when a mounted motor is replaced with another motor having a different number of poles can be easily solved. Moreover malfunction of a system can be prevented from occurring due to malfunction of a BLDC motor when information about the number of poles of a replaced motor is erroneously inputted by a worker.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A controlling apparatus to control a BLDC motor, the controlling apparatus comprising:
a current detector to detect a load current of the BLDC motor; and
a controller to detect a replacement of the BLDC motor with another BLDC motor having a different number of poles based on a variation of the detected load current from a reference load current, to determine the number of poles of the replaced BLDC motor, to modify the reference rotation speed estimation information to new rotation speed estimation information corresponding to the number of poles of the replaced BLDC motor, and to control a rotation speed of the replaced BLDC motor according to the new rotation speed estimation information.

2. The controlling apparatus according to claim 1, wherein the rotation speed estimation information comprises the number of frequency generator pulses per revolution of a rotor of the BLDC motor.

3. The controlling apparatus according to claim 2, wherein the number of frequency generator pulses per revolution of the rotor of the BLDC motor is six when the BLDC motor is a 4-pole BLDC motor, twelve when the BLDC motor is an 8-pole BLDC motor, and twenty four when the BLDC motor is a 16-pole BLDC motor.

4. The controlling apparatus according to claim 1, wherein the controller detects that the BLDC motor is replaced with the another BLDC motor having the number of poles greater than a reference number of poles when the detected load current is less than a reference load current, and that the BLDC motor is replaced with the another BLDC motor having the number of poles less than a reference number of poles when the detected load current is greater than the reference load current.

5. The controlling apparatus according to claim 4, wherein the controller determines the number of poles of the replaced BLDC motor using a current difference between the detected load current and the reference load current.

6. A controlling method of a controlling apparatus to control a BLDC motor, the controlling method comprising:
detecting a load current of a BLDC motor;
detecting a replacement of the BLDC motor with another BLDC motor having a different number of poles based on a variation of the detected load current from a reference load current and determining the number of poles of the replaced BLDC motor; and
modifying reference rotation speed estimation information to new rotation speed estimation information corresponding to the determined number of poles of the BLDC motor to control a rotation speed of the replaced BLDC motor according to the new rotation speed estimation information.

7. The controlling method according to claim 6, wherein it is determined that the BLDC motor is replaced with a BLDC motor having the number of poles greater than a reference number of poles when the detected load current is less than the reference load current, and it is determined that the BLDC motor is replaced with a BLDC motor having the number of poles less than a reference number of poles when the detected load current is greater than the reference load current.

8. The controlling method according to claim 7, wherein the number of poles of the BLDC motor is determined by a difference between the detected load current and the reference load current.

9. The controlling method according to claim 6, wherein the rotation speed estimation information comprises the number of frequency generator pulses per revolution of a rotor of the BLDC motor.

10. A controlling apparatus to control a BLDC motor, comprising:
a BLDC motor;
an inverter to drive the BLDC motor;
an inverter driver to control the inverter;
a detector connected between the inverter and a potential to detect a current of the inverter; and
a controller to determine the number of poles of the BLDC motor according to the detected current and a reference.

11. The controlling apparatus according to claim 10, wherein the controller controls the inverter driver according to the determined number of poles and reference rotation speed estimation information.

12. The controlling apparatus according to claim 11, wherein the controller modifies the reference rotation speed estimation information according to the determined number of poles.

13. The controlling apparatus according to claim 11, wherein the controller estimates a rotation speed of the BLDC motor according to pulses generated from the BLDC motor and the reference rotation speed estimation information corresponding to the number of poles

14. The controlling apparatus according to claim 10, wherein the controller determines the number of poles of the BLDC motor according to a different between the detected current and the reference.

15. The controlling apparatus according to claim 10, wherein the controller determines the number of poles of the BLDC motor according to a variation of the detected current.

16. The controlling apparatus according to claim 10, wherein the controller controls the inverter driver according to the detected current and pulses generated from the BLDC motor.

17. The controlling apparatus according to claim 10, wherein the inverter comprises a plurality of transistors having an emitter terminal, and the detector is coupled between the potential and the emitter terminal.

18. The controlling apparatus according to claim 10, wherein the controller controls the inverter driver to adjust a speed of the BLDC motor according the determined number of the poles.

19. The controlling apparatus according to claim 10, wherein the controller generates a signal indicating that the BLDC motor is not a reference BLDC motor according to the determined number of poles.
